(19) United States
(12) Patent Application Publication
(10) Pub. No.: US 2017/0311383 A1
(43) Pub. Date: Oct. 26, 2017

(54) COOKTOP WITH REMOVABLE RECEPTACLE

(71) Applicants: BSH Home Appliances Corporation, Irvine, CA (US); BSH Hausgeräte GmbH, Munich (DE)

(72) Inventor: Andy Mok, Stanton, CA (US)

(21) Appl. No.: 15/135,598

(22) Filed: Apr. 22, 2016

(51) Int. Cl. H05B 1/02; H05B 3/68

(52) U.S. Cl. CPC H05B 1/0266; H05B 3/681

(57) ABSTRACT

A cooktop configured to be mounted in a domestic appliance is provided. The cooktop has a top surface; a plurality of heating units located on the top surface; a receiving area in the top surface; and a receptacle removably positioned in the receiving area of the cooktop, the receptacle having an opening at an upper end of the receptacle. The receptacle is configured to receive through the opening material collected from the top surface of the cooktop for subsequent removal from the domestic appliance by removal of the receptacle from the top surface of the cooktop.

### FIELD OF THE INVENTION

The invention is directed to an apparatus such as a cooktop having a removable receptacle for easy cleaning.

An example of an application of the invention is a removable receptacle in a cooktop in a domestic kitchen.

### BACKGROUND OF THE INVENTION

Domestic appliances, such as cooktops that are part of a cooking range or counter mounted cooktops, can require regular cleaning, particularly after use. The cooktop can become heated during use and material, such as food and grease, can become hardened and stick to the surface of the cooktop. A user cleans the cooktop surface to collect spilled food and grease, for example, by collecting and removing them to a remote refuse collection area. A user can use disposable cleaning cloths to clean the cooktop surface, and dispose of those individually to the remote refuse collection area as well.

The problem with existing appliances is that a user typically makes multiple trips away from the cooktop surface during cleaning in order to remove foodstuff, debris, and/or disposable cleaning cloths to a remote refuse collection area, such as a garbage can, garbage disposal, or compost collection. The user wastes time walking back and forth to the appliance, and cleaning takes longer than necessary. In addition, often particles of the cleaning cloth and/or the debris are dropped on the kitchen floor during transport of the used cleaning cloth to the remote refuse collection area.

### SUMMARY

Exemplary embodiments of the invention overcome the problems in conventional appliances by providing a receptacle in the top surface of the cooktop so that a user can collect material for subsequent removal in a single trip to a remote refuse collection area. The user can clean the entire cooktop surface and deposit collected material, including foodstuff and disposable cleaning cloths, into a removable receptacle on the top of the cooktop surface. When the user has completed cleaning the cooktop surface, the receptacle can be easily removed via the top of the cooktop surface and all of the collected material can be deposited to a remote refuse collection area in a single action.

Particular embodiments of the invention include a domestic appliance having a cooktop having a top surface; a plurality of heating units located on the top surface; a receiving area in the top surface; and a receptacle removably positioned in the receiving area, the receptacle having an opening at an upper end of the receptacle. The receptacle is configured to receive through the opening material collected from the top surface of the cooktop for subsequent removal from the domestic appliance by removal of the receptacle from the top surface of the cooktop.

Other embodiments of the invention include a cooktop configured to be mounted in a domestic appliance. The cooktop has a top surface; a plurality of heating units located on the top surface; a receiving area in the top surface; and a receptacle removably positioned in the receiving area of the cooktop, the receptacle having an opening at an upper end of the receptacle. The receptacle is configured to receive through the opening material collected from the top surface of the cooktop for subsequent removal from the domestic appliance by removal of the receptacle from the top surface of the cooktop.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is an exemplary embodiment of a domestic range having a cooktop;

FIG. 2 is a cooktop in accordance with exemplary embodiments of the invention;

FIG. 3 is a cooktop in accordance with exemplary embodiments of the invention;

FIG. 4 is a front view of a cooktop in accordance with exemplary embodiments of the invention;

FIG. 5 is a receptacle in accordance with exemplary embodiments of the invention;

FIG. 6 is another receptacle in accordance with exemplary embodiments of the invention;

FIG. 7 is another receptacle in accordance with exemplary embodiments of the invention; and

FIG. 8 is another receptacle in accordance with exemplary embodiments of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

Cleaning a cooktop surface can be challenging when food, grease, and other substances stick to the surface. Users typically make multiple trips to a remote refuse collection area, such as a garbage can, garbage disposal, and compost collection, to deposit material removed from the cooktop surface, which can be tiresome and time consuming. The present invention eliminates the need for multiple trips by providing a receptacle on the cooking surface that can be removed to deposit material in one trip.

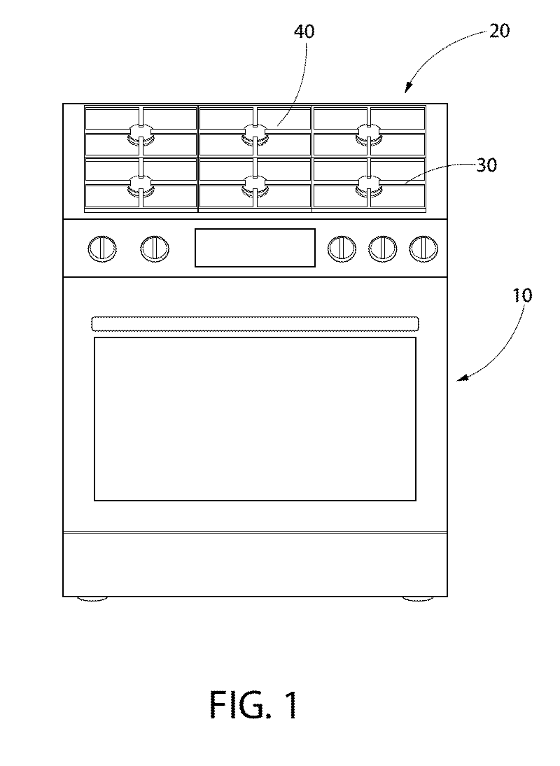

FIG. 1 shows a domestic appliance such as, for example, a range 10. The range 10 has a cooktop 20 and grates 30 positioned on a top surface 40 of the cooktop 20. Other appliances in accordance with the invention include cooktops that are built into a countertop.

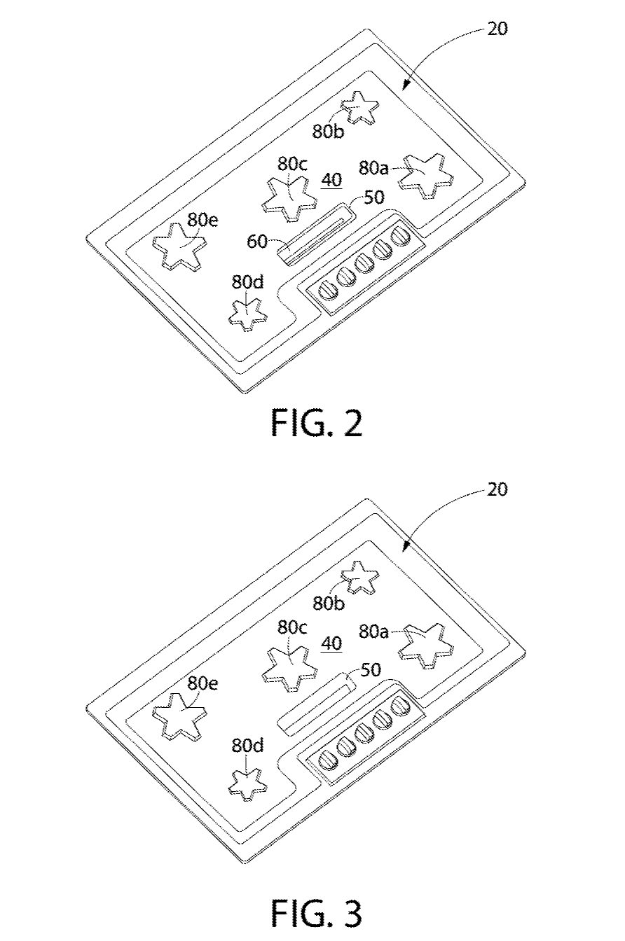

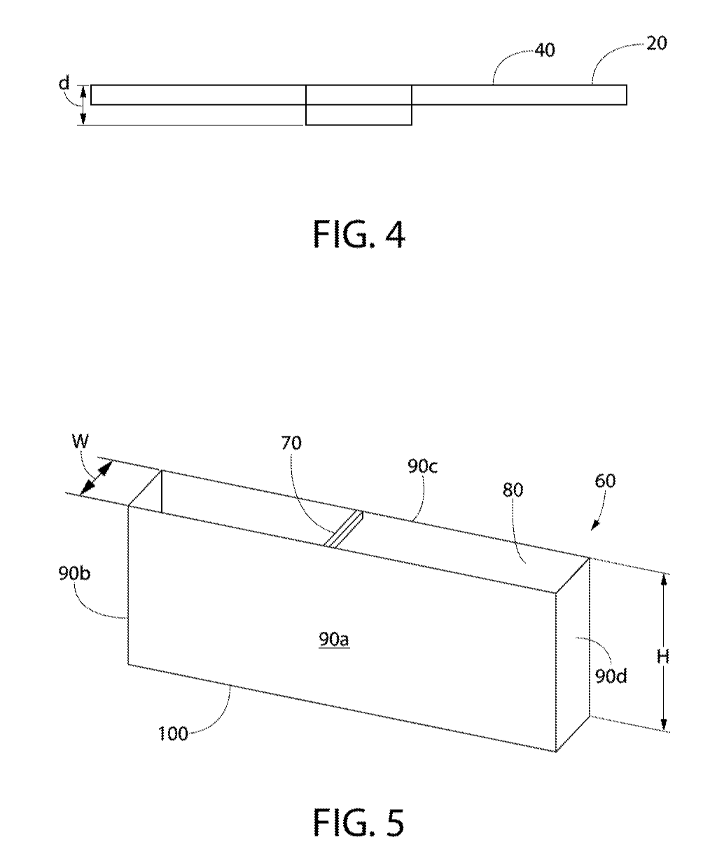

FIG. 2 shows an embodiment of the invention in which the cooktop 20 has a recess 50 on the top surface 40 of the cooktop. A receptacle 60 can be positioned inside the recess 50. The receptacle 60 can be removable from the recess 50, as shown in FIG. 3. The recess 50 can be a depression or indentation in the top surface of the cooktop, having a depth d, for example, as shown in FIG. 4. Alternatively, the recess 50 can be an aperture having no bottom so that the receptacle 60 extends a depth d through the top surface 40 of the cooktop. The top surface 40 of the cooktop 20 can be made of, for example, sheet metal, and can include a plurality of gas burners. In the example shown in FIGS. 2 and 3, the cooktop 20 has five gas burners 80a, 80b, 80c, 80d, 80e arranged on the top surface 40 of the cooktop 20. The top surface 40 of the cooktop 20 can become heated during use when gas burner 80a-e operate. During cooking, material such as food can spill onto the top surface 40 of the cooktop 20, and the heated surface can cause the spilled material to adhere to the surface, making cleaning difficult.

FIGS. 5-8 show exemplary embodiments of receptacles in accordance with the invention.

FIG. 5 shows an example of a receptacle 60 having an opening 80 in its upper end. The opening 80 allows for material such as food, grease, and cleaning cloths to be placed in the receptacle 60 during the cleaning operation. In this example, the receptacle 60 is essentially a rectangular parallelepiped having four sides 90a, 90b, 90c, 90d and a bottom 100. A handle 70 is provided to facilitate lifting and carrying of the receptacle 60. The handle 70 can be connected to the receptacle 60 for easy removal from the recess 50. The handle 70 can be a protrusion across a width of the receptacle 60 so that the handle does not project into the space of the cooktop. The handle 70 can be positioned in the center of the receptacle 60, as shown in FIG. 5. A handle can be positioned to a side of the receptacle or can be hinged to fold between a carrying position and a non-carrying position. More than one handle can be positioned on the receptacle. For example, handles can be provided on two sides of the receptacle so that a user can use two hands for removal. The handle can be any design to facilitate removal of the receptacle. The handle can be attached to the receptacle in any known manner, such as welding or fastening. The receptacle can have apertures to receive ends of the handle. The handle can be positioned so as to not extend above the cooktop surface, but to be flush to the surface so as not to interfere with cooking utensils such as pots and pans on the gas burners. The handle can also be designed to extend slightly above the cooktop surface. The receptacle 60 has a height H and width W. The corresponding recess 50 in the top surface 40 of the cooktop 20 can be the same shape as the receptacle 60 in order to provide a high quality looking fit when the receptacle 60 is in place in the recess 50. The recess 50 can be a closed pocket, it can be a mesh pocket, it can be one or more bars, it can be an opening in the top surface 40 that has no bottom, or it can be any combination of these features.

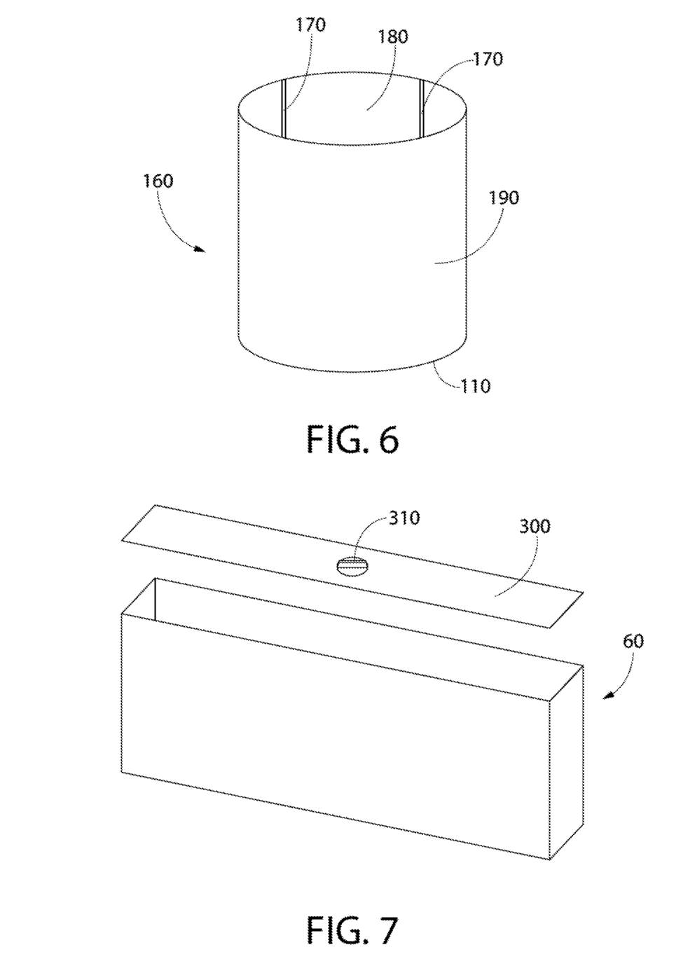

FIG. 6 shows an example of a receptacle 160 having an opening 180 in its upper end. The opening 180 allows for material such as food, grease, and cleaning cloths to be placed in the receptacle 160 during the cleaning operation. In this example, the receptacle 160 is a circular cylinder having a side 90 and a bottom 110. In this example, two handles 170 are provided to facilitate lifting and carrying of the receptacle 160. The handles 170 can be connected to the receptacle 160 for easy removal from the recess in the top surface of the cooktop. The handles 170 can be protrusions across a mouth of the receptacle 160 so that the handles do not project into the space of the cooktop. In other embodiments, one handle 170 can be positioned in the center of the receptacle 160. The handles 170 can be positioned to a side of the receptacle or can be hinged to fold between a carrying position and a non-carrying position. The handles can be any design to facilitate removal of the receptacle. The handles can be attached to the receptacle in any known manner, such as welding or fastening. The receptacle can have apertures to receive ends of the handles. The handles can be positioned so as to not extend above the cooktop surface, but to be flush to the surface so as not to interfere with cooking utensils such as pots and pans on the gas burners. The handles can also be designed to extend slightly above the cooktop surface. The corresponding recess in the top surface of the cooktop can be the same shape as the receptacle 160 in order to provide a high quality looking fit when the receptacle 160 is in place in the recess. The recess can be a closed pocket, it can be a mesh pocket, it can be one or more bars, it can be an opening in the top surface of the cooktop that has no bottom, or it can be any combination of these features.

The receptacle can have a cover 300, as shown in FIG. 7. As an example, the cover 300 is shown corresponding to the receptacle 60 of FIG. 5. Other receptacles can have covers that correspond to the respective shapes of those receptacles. The cover 300 can be fully detachable from the receptacle 60, and include a handle 310 on an outer surface of the cover 300 so that a user can remove the cover 300 to deposit material into the receptacle 60. The cover 300 can attached to the receptacle 60 in a known manner, such as hingedly connected on one side of the receptacle 60 with a latch and/or clasp to keep the cover 300 closed on the receptacle 60. The cover 300 can be rotatable around the hinge. The handle 310 can be rotatable to disengage the latch and/or clasp to open the cover 300 from the receptacle 60. The handle 310 can also be a hole in the cover 300 designed to allow a user to lift the cover 310 by placing a finger in the hole 310.

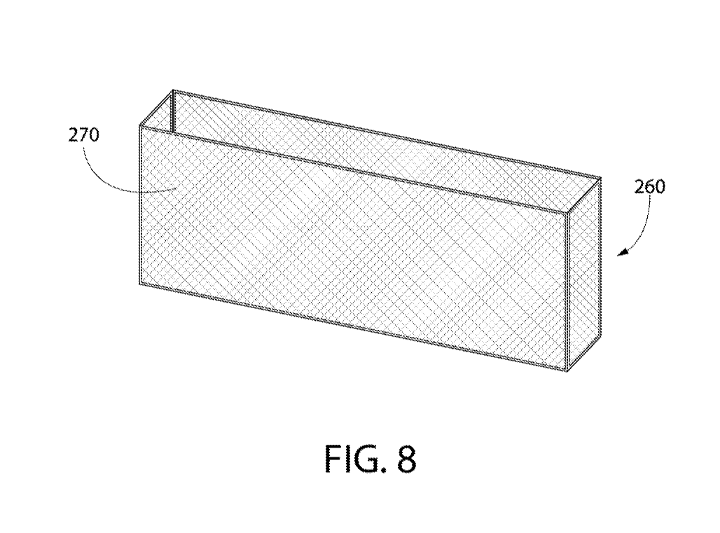

FIG. 8 shows an example of a receptacle 260 that is made of a wire mesh 270. The receptacle 260 is similar in shape to the receptacle 60 shown in FIG. 5, but is made of the wire mesh material 270 instead of a solid material.

While FIGS. 5-8 show example of rectangular and round receptacle, other shapes can also be used, such as, for example, square, trapezoidal, or oval. The corresponding recess in the top surface of the cooktop can be the same shape as the receptacle in order to provide a high quality looking fit when the receptacle 160 is in place in the recess. The receptacle, of any shape, can have a lip that rests on the top surface of the cooktop. The lip can help properly position the receptacle in the recess and can help ensure that the debris and cleaning cloths are deposited into the receptacle and do not fall between the receptacle and the top surface. The receptacle can be made of any material suitable in a cooktop environment, for example, stainless steel or heat resistant plastic.

The recess and the receptacle can be centered on the top surface of the cooktop, as shown in FIGS. 2 and 3. The recess can be positioned elsewhere on the top surface of the cooktop depending on other features of the cooktop such as, for example, the configuration of the gas burners or other heating units. For example, the configuration of the gas burners can affect the placement of the recess and receptacle on the top surface of the cooktop as a result of heat transfer of the gas burners. In addition, the configuration of components beneath the cooktop surface can affect the placement and size of the recess. It is advantageous for the receptacle to be in the cooking area so a user can easily utilize the receptacle while cleaning the cooktop as opposed to a location off the cooktop surface. It is also advantageous to have the receptacle removable from the top surface of the cooktop so as to allow for easy removal and replacement after cleaning.

The receptacle 60, 160, 260 can be removed from the recess of the top surface of the cooktop to remove material, debris, and trash deposited into it by a user. For example, a user may be cleaning the cooktop surface and need to deposit material collected from the cooktop surface. Instead of walking away from the cooktop to deposit material in a trash can or other collected area, the user can deposit material directly into the receptacle. Once the user has completed cleaning the cooktop, the receptacle can be removed from the recess on the cooktop surface to deposit all of the material collected into a trash can or other area. This prevents a user from having to make multiple trips away from the cooktop during cleaning to deposit material and trash to a remote garbage can or other area.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the invention.

What is claimed is:

1. A domestic appliance, comprising:
a cooktop having a top surface;
a plurality of heating units located on the top surface;
a receiving area in the top surface; and
a receptacle removably positioned in the receiving area, the receptacle having an opening at an upper end of the receptacle;
wherein the receptacle is configured to receive through the opening material collected from the top surface of the cooktop for subsequent removal from the domestic appliance by removal of the receptacle from the top surface of the cooktop.

2. The domestic appliance of claim 1, wherein the opening of the receptacle and the top surface of the cooktop are coplanar.

3. The domestic appliance of claim 1, wherein the receptacle includes a cover for the opening.

4. The domestic appliance of claim 1, wherein the receptacle includes a handle.

5. The domestic appliance of claim 1, wherein the receptacle is a basket.

6. The domestic appliance of claim 1, wherein the receptacle has a rectangular cross-section, having four sides connected to a bottom end, the bottom end being opposite the opening.

7. The domestic appliance of claim 1, wherein the receptacle is a circular cylinder.

8. The domestic appliance of claim 1, wherein the receiving area in the cooktop is an aperture in the top surface of the cooktop.

9. The domestic appliance of claim 1, wherein the receiving area in the cooktop is a depression in the top surface of the cooktop such that the top surface of the cooktop surrounds the receptacle in the receiving area.

10. The domestic appliance of claim 1, wherein a depth of the receiving area is substantially equal to a height of the receptacle such that when the receptacle is in the receiving area an upper edge of the receptacle is flush to the top surface of the cooktop.

11. The domestic appliance of claim 1, wherein a depth of the receiving area is greater than a height of the receptacle such that when the receptacle is in the receiving area an upper edge of the receptacle is below the top surface of the cooktop.

12. A cooktop configured to be mounted in a domestic appliance, comprising:
a top surface;
a plurality of heating units located on the top surface;
a receiving area in the top surface; and
a receptacle removably positioned in the receiving area of the cooktop, the receptacle having an opening at an upper end of the receptacle;
wherein the receptacle is configured to receive through the opening material collected from the top surface of the cooktop for subsequent removal from the domestic appliance by removal of the receptacle from the top surface of the cooktop.

13. The cooktop of claim 12, wherein the opening of the receptacle and the top surface of the cooktop are coplanar.

14. The cooktop of claim 12, wherein the receptacle includes a cover for the opening.

15. The cooktop of claim 12, wherein the receptacle includes a handle.

16. The cooktop of claim 12, wherein the receptacle is a basket.

17. The cooktop of claim 12, wherein the receptacle has a rectangular cross-section, having four sides connected to a bottom end, the bottom end being opposite the opening.

18. The cooktop of claim 12, wherein the receptacle is a circular cylinder.

19. The cooktop of claim 12, wherein the receiving area in the cooktop is an aperture in the top surface of the cooktop.

20. The cooktop of claim 12, wherein the receiving area in the cooktop is a depression in the top surface of the cooktop such that the top surface of the cooktop surrounds the receptacle in the receiving area.

21. The cooktop of claim 12, wherein a depth of the receiving area is substantially equal to a height of the receptacle such that when the receptacle is in the receiving area an upper edge of the receptacle is flush to the top surface of the cooktop.

22. The cooktop of claim 12, wherein a depth of the receiving area is greater than a height of the receptacle such that when the receptacle is in the receiving area an upper edge of the receptacle is below the top surface of the cooktop.
